(19) United States
(12) Patent Application Publication
(10) Pub. No.: US 2026/0268178 A1
(43) Pub. Date: Sep. 10, 2026

(54) SYSTEMS AND METHODS FOR GENERATING ROLE-PLAYING AI PERSONAS CONSTRUCTED FROM VARIOUS MARKETING SEGMENTS

(71) Applicant: Vurvey Labs, Inc., Cincinnati, OH (US)

(72) Inventors: Benjamin Vaughan, Cincinnati, OH (US); Eric Poff, Cincinnati, OH (US); Jason Roell, Cincinnati, OH (US); Chad Reynolds, Cincinnati, OH (US)

(21) Appl. No.: 19/551,943

(22) Filed: Feb. 27, 2026

Related U.S. Application Data
(60) Provisional application No. 63/767,299, filed on Mar. 5, 2025.

(51) Int. Cl. G06N 5/04; G06N 20/00

(52) U.S. Cl. CPC G06N 5/04; G06N 20/00

(57) ABSTRACT

Methods and systems are described for an AI persona generation system. A system can provide groups of AI personas with specific facets reflecting a desired consumer group. AI/ML tools can be used to optimize the generation of AI personas. Systems and methods include receiving, via a user interface, a request for one or more artificial-intelligence (AI) personas; determining, by the persona generation server, a plurality of key persona facets for the request; generating an AI persona mold based on the plurality of key persona facets; generating, by an artificial intelligence/machine learning (AI/ML) model, a plurality of AI personas consistent with the persona mold; and validating the plurality of AI personas based on one or more validation criteria.

### CROSS REFERENCE TO RELATED INFORMATION

This application claims the benefit of U.S. application Ser. No. 63/767,299 filed on Mar. 5, 2025, titled “SYSTEMS AND METHODS FOR GENERATING ROLE-PLAYING AI PERSONAS CONSTRUCTED FROM VARIOUS MARKETING SEGMENTS,” the contents of which are hereby incorporated herein in its entirety.

### TECHNICAL FIELD

The disclosed technology pertains to systems and methods for generation of AI personas.

### BACKGROUND

There are many processes for generating artificial intelligence (“AI”) personas. Often these processes struggle to generate AI personas that accurately reflect a human and/or a population of humans, and they often lack the ability to stay up to date with real-time opinion changes.

### SUMMARY

One embodiment under the present disclosure comprises a computer-implemented method performed by a persona generation server comprising one or more processors and memory, the method comprising: a) receiving, via a user interface, a request for one or more artificial-intelligence (AI) personas; b) determining, by the persona generation server, a plurality of key persona facets for the request; c) generating an AI persona mold based on the plurality of key persona facets; d) generating, by an artificial intelligence/machine learning (AI/ML) model, a plurality of AI personas consistent with the persona mold; and e) validating the plurality of AI personas based on one or more validation criteria.

Another embodiment under the present disclosure is a computer-implemented method for conducting focus-group-style evaluations using AI personas, comprising: a) receiving media through a controlled ingress; b) for each of a plurality of AI personas: i) parsing the media to obtain a latent representation; ii) updating persona memory using a memory-retention model; and iii) generating evaluative outputs using a subjective evaluation model; c) normalizing the evaluative outputs across the plurality of AI personas using exposure-normalization and bias-mitigation components; d) iteratively refining the evaluative outputs until a convergence criterion is met; and e) producing cohort-level preference rankings for the plurality of AI personas.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates an embodiment of a system for generating role-playing AI personas under the present disclosure;

FIG. 2 illustrates an embodiment of a user interface for displaying an AI persona facet;

FIG. 3 illustrates an embodiment of a persona generation server;

FIG. 4 illustrates an embodiment of a data engine;

FIG. 5 illustrates an embodiment of a benchmark system;

FIG. 6 illustrates an embodiment of a method for generating role-playing AI personas under the present disclosure;

FIG. 7 illustrates an exemplary data-flow architecture in which proprietary or otherwise confidential media may be securely provided to a cohort of AI personas for internal processing, memory state updating, and evaluative output generation;

FIG. 8 illustrates an exemplary method for conducting focus-group-style evaluations using AI personas;

FIG. 9 shows an example flow chart of training and inference pipelines for machine learning in accord with some embodiments under the present disclosure;

FIG. 10 shows an embodiment of a neural network under the present disclosure; and

FIG. 11 shows an embodiment of a computing device for use in various embodiments under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the marketing and product research industries. In marketing and product research, focus groups and consumer research can be critical to successful campaigns and products. Focus groups and consumer research often rely on gathering nuanced opinions from individual people. These people may have specific characteristics relevant to a product or campaign. Often finding people that fit the relevant characteristics of a target consumer group takes significant investment on the company's part, both in time and money. This can be exacerbated by niche or otherwise hard to reach consumer groups for some products or campaigns. This can lead to companies taking unnecessary risks on products and campaigns, scrapping potential products and campaigns, and/or reducing innovation efforts in areas with consumers that are hard to reach. As a result, there are numerous opportunities in this area, but often these opportunities are limited due to the inability to obtain substantive feedback and research on specific consumer groups.

Certain aspects of the embodiments disclosed herein provide solutions to these or other challenges. Certain embodiments include various functionalities. Certain embodiments include an AI persona generation system. Certain embodiments include autonomous generation of AI personas based on input persona descriptions. Certain embodiments include an AI persona generation system comprising a neural network capable of identifying key persona facets based on input persona descriptions. Other embodiments comprise systems and methods for generation of AI personas.

Certain embodiments may provide one or more of the following technical advantages. Embodiments can achieve greater ability to perform market and consumer research, guide expert AI personas, anthropomorphize non-human entities, and/or discover aspects of a person's personality or behavior. Certain embodiments can collect large amounts of data to aid in optimizing the AI persona generation system.

The use of AI personas for focus-group-type testing may provide numerous technical advantages over traditional human-subject research. Human participants in focus groups often suffer from fatigue, loss of attention, declining engagement, and/or order-dependent bias when exposed to long sequences of concepts or extended testing sessions. By contrast, AI personas can maintain consistent evaluative behavior regardless of session length and do not require breaks, allowing the execution of high-volume, high-fidelity concept evaluations without the performance degradation inherent to human subjects. This may enable repeated or large-scale exposure to creative variants, advertisements, and/or product concepts without compromising the consistency of responses.

Further, human recall is inherently imperfect. Human participants may forget early stimuli, confuse multiple concepts, and/or unintentionally distort their recollections. Embodiments herein may leverage knowledge facets, exposure estimators, and/or memory-retention models to control recall dynamics, which may enable perfect recall, human-like decay, or intermediate states depending on testing needs. This may eliminate cross-contamination between stimuli and allow more precise comparisons across large numbers of concepts. AI personas also do not inherently experience emotional saturation, boredom, or response anchoring effects, conditions that commonly reduce the reliability of human focus-group data. Anti-fatigue scheduling and/or controlled-exposure mechanisms may ensure that AI persona evaluations remain stable across long testing sequences. This may create a higher-throughput and more statistically robust environment than is achievable with traditional human panels.

Another technical advantage may be that AI-persona-based focus-group testing can provide a secure black-box environment for evaluating proprietary or sensitive materials. Human focus-group testing inherently carries a risk of information leakage, for example participants may record, share, or otherwise disclose unreleased advertisements, film trailers, product designs, messaging strategies, or confidential marketing assets. An AI-persona-based focus-group may ingest such sensitive materials into a black-box sandbox and leak-prevention vault, where AI personas, rather than human viewers, are permitted to access or evaluate the content. This architecture may ensure that confidential or pre-release creative materials can remain isolated within a controlled computational environment and may not be directly exposed to human participants.

As a result, AI personas may provide focus-group-style evaluations of unreleased materials while maintaining confidentiality, which may enable companies to test creative assets earlier in the development cycle and at significantly reduced risk. This architecture may also allow for post-mortem testing, controlled competitive comparisons, and/or iterative creative refinement without public exposure or human-subject disclosure obligations. The fatigue-free, memory-controlled, and bias-reduced nature of AI persona testing, along with these security properties, this AI-persona-based concept evaluation may be a superior, more scalable, and/or more reliable alternative to conventional human focus-group methodologies.

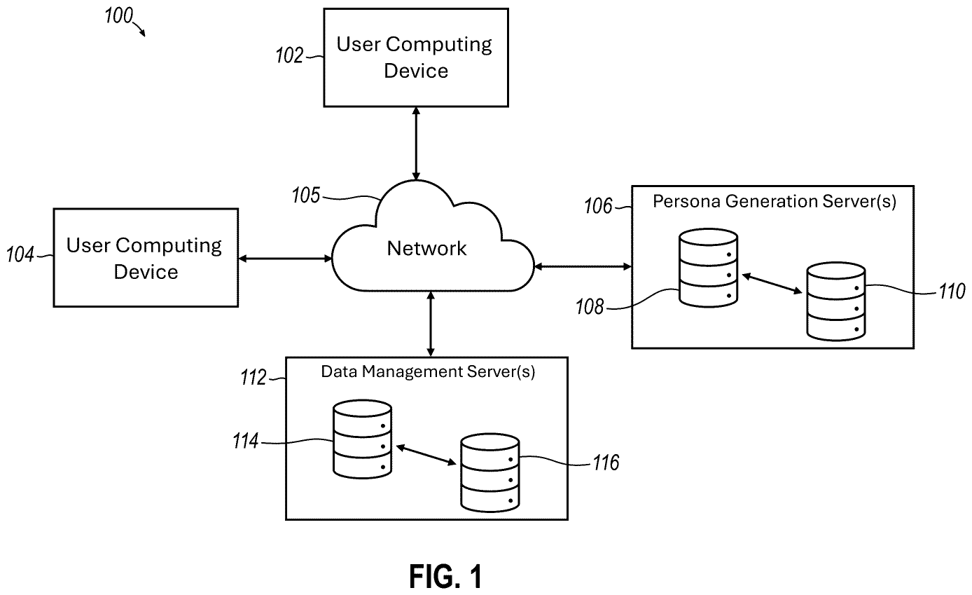

Referring now to FIG. 1, one embodiment of an AI persona generation system 100 is shown. One or more user computing devices 102, 104 (e.g., computers, tablets, mobile devices, etc.) can use network hanks, (e.g., Internet, cellular, Bluetooth™, Wi-FI, satellite, enterprise, private network, similar networks, or combinations of the foregoing) to access one or more persona generation servers 108, 110, collectively 106, and one or more data management servers 114, 116, collectively 112. The one or more persona generation servers 106 may perform a variety of functions, such as analyzing AI persona requests, generating AI personas, validating AI personas, generating AI persona families, generating AI persona molds, or other functions as described herein. The one or more data management servers 112 may integrate with the one or more persona generation servers 106 (e.g., via network 105) to perform a variety of functions, such as collect, monitor, or analyze marketing, consumer, facet, and/or AI persona data; monitor and manage consumer data sources; monitor and manage trend data; and other functions as described herein. Various embodiments of the AI persona generation system 100 may have artificial intelligence/machine learning (“AI/ML”) functionalities. An AI/ML engine may be stored or operated at various computing devices within the AI persona generation system 100. Any or all of the one or more user computing devices 102, 104, network 105, the one or more persona generation servers 106, and/or the one or more data management servers 112 may comprise an AI/ML engine(s). An AI/ML engine may comprise or perform AI/ML functionality as described further herein.

Several functionalities offered by e.g., AI persona generation system 100 may include: consumer and trend analytics, AI/ML-enhanced AI persona generation tools, AI persona generation, AI persona request analytics, and AI persona validation.

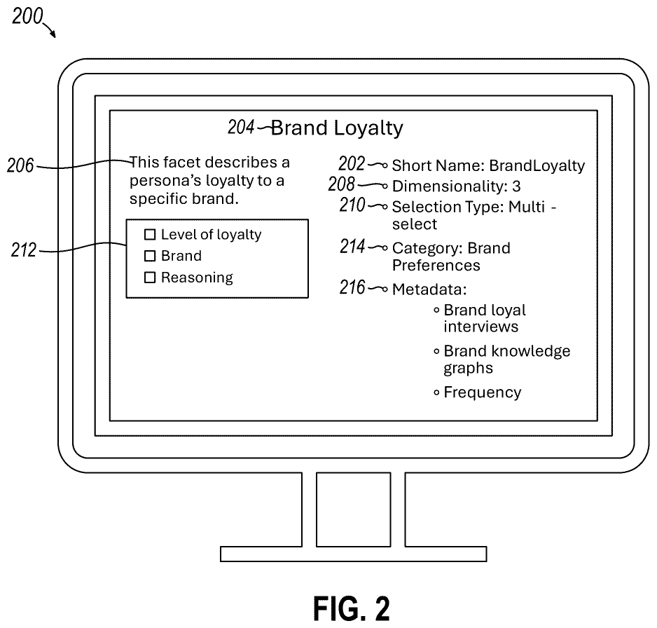

FIG. 2 illustrates an embodiment of a user interface for displaying an AI persona facet. A facet 200 may be an aspect of a person or persona that may be used to generate AI personas and/or construct prompt fragments along with datasets and workflows. A facet 200 may include a short name 202 which may be used for backend identification, display name 204, description 206, dimensionality 208, selection type 210, facet options 212, category 214, metadata 216, and/or other elements. A short name 202 may be an internal name. A display name 204 may be a name shown to a user within a user interface. A description 206 may be a short (e.g., one or two sentences) description that may provide clarity about what the facet represents. A dimensionality 208 may be a number of selections required to be chosen for a facet. A selection type 210 may be the selection behavior of the facet, such as single-select or multi-select. A single-select facet may be a facet where only one option may be chosen. For example, a facet may be height, where there is only one answer. A multi-select facet may be facet where multiple options can be chosen. For example, a facet may be preferred grocery store(s), where there someone may have multiple preferred grocery stores. Facet options 212 may include a list of options that can be selected for the facet. A category 214 may be a classification of a purpose of the facet or what it models. Metadata 216 may include additional information about the facet. In some embodiments, subsets of facet information may be displayed to a user rather than all available information. These subsets may be determined by an administrator or an AI/ML engine such that only relevant data is displayed.

In some versions, facets may include knowledge facets that may encode what a persona knows or has been exposed to, independent of the persona's preferences or behaviors. Knowledge facets can be supported by an exposure estimator that may model the likelihood a persona, or cohort of personas, has encountered a stimulus (e.g., an advertisement, film trailer, headline, product placement, etc.) as a function of media consumption patterns, geography, social graph proximity to influencers, time, and/or other factors. A memory retention model may represent awareness, forgetting, and partial recall, which may enable downstream tasks to differentiate between non-exposure, exposure without recall, and exposure with recall. A subjective evaluation model may then attach sentiment or stance to remembered stimuli. In some versions, a media-consumption facet may capture channels, frequency, and/or recency that may parameterize the exposure estimator. Further, the facet schema can represent neurodivergence traits as optional facets, with support for inner-monologue outputs to externalize reasoning for personas who may not conventionally express in standard conversational forms, which may enable more faithful simulation of diverse cognitive styles.

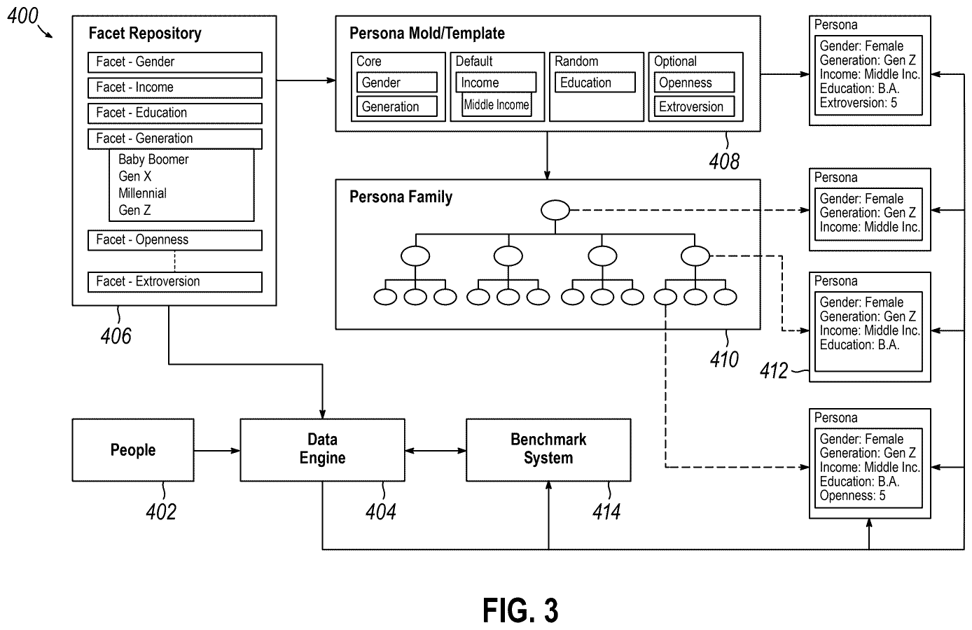

FIG. 3 illustrates an embodiment of a persona generation server 400, as shown in FIG. 1. Persona generation server 400 may include a facet repository 406, an AI persona mold 408, a persona family 410, one or more AI personas 412, and a benchmark system 414. The persona generation server 400 may communicate with a data engine 404. The data engine 404 may be part of the one or more data management servers 112 as described in FIG. 1. The data engine 404 may receive and store people data 402 and may communicate such data with the benchmark system 414 and the facet repository 406. People data 402 may include video, written, and/or verbal surveys of humans which may be categorized by facets; data scraped from online sources which may be categorized by facets; data from varying personality analysis tools/tests which may be categorized by facets; or other data which may be organized by facets. The data engine 404 may store, organize, manage, or otherwise manipulate the people data 402. A facet repository 406 may be a collection of facets that can be chosen from to create a new AI persona. An AI persona mold 408 may be a template that describes the key facets chosen from the repository used to build sets of personas. For example, an AI persona mold 408 may be a set of key facets set to a specified option such that all future generated AI personas may have a core set of facets that are the same or similar. An AI persona mold 408 may also include a set of facets that may be set to varying or default options to aid in generating a realistic reflection of a group of people with similar facets, or other goal, group of AI personas. In some embodiments, some facets may be included as optional. For example, an AI persona mold 408 may include a generation facet set to Gen Z, a gender facet set to male, a brand preference facet set to vary, and a brand loyalty facet set to vary. This example AI persona mold 408 may generate AI personas that reflect Gen Z males with varying brand preferences and varying levels of brand loyalty.

A persona family 410 may be a tree of AI personas descended from a given AI persona model, capturing the variance of facets that were not explicitly selected. For example, as with the example above of Gen Z males, the top of the tree may represent Gen Z males, the next layer may include Gen Z males with each variance of a facet 1, the next layer of the tree may include Gen Z males with each variance of facet 1 with each variance of facet 2, etc. until all relevant facets are incorporated, a desired level of detail is met, or another goal is achieved. An AI persona of the one or more AI personas 412 may be a collection of facets used to create prompts, datasets, and workflows that define the behavior of an AI agent configured to communicate with a user as a desired consumer, consumer group, or other desired entity. A benchmark system 414 may be a system for scoring a persona on how closely its responses are to expected and/or interview responses. In some embodiments, the data engine 404 may receive a request for one or more AI personas from a user to begin generation of one or more AI personas.

In some versions, the persona generation server 400 may include a population constructor module which may assemble reusable, large-scale persona populations from facets stored in the facet repository 406 and/or from people data 402. The population constructor module may generate stratified or clustered cohorts that reflect demographic, psychographic, behavioral, and/or market-specific distributions, and can persist such cohorts in a population repository for re-use across engagements. A localization engine may derive culturally nuanced psychological profiles and localized defaults (e.g., idioms, values, norms, media references, preference priors, etc.) for each market or subculture. These profiles can be sourced from public datasets, enterprise datasets, commercial audience-measurement datasets, and/or other datasets accessed by data engine 404. In some versions, the localization engine may automatically create a persona skeleton by mining publicly available, market-level signals, and then filling the skeleton with market-specific facets and options before validation via the benchmark system 414. A persona growth model may enable temporal evolution of personas, adapting individual facets and/or cohort-level distributions as new exposures, experiences, and/or events are observed (e.g., seasonal shifts, trend shocks, longitudinal maturation of a generation, etc.), thereby updating both the one or more AI personas 412 and population-level summaries in the population repository.

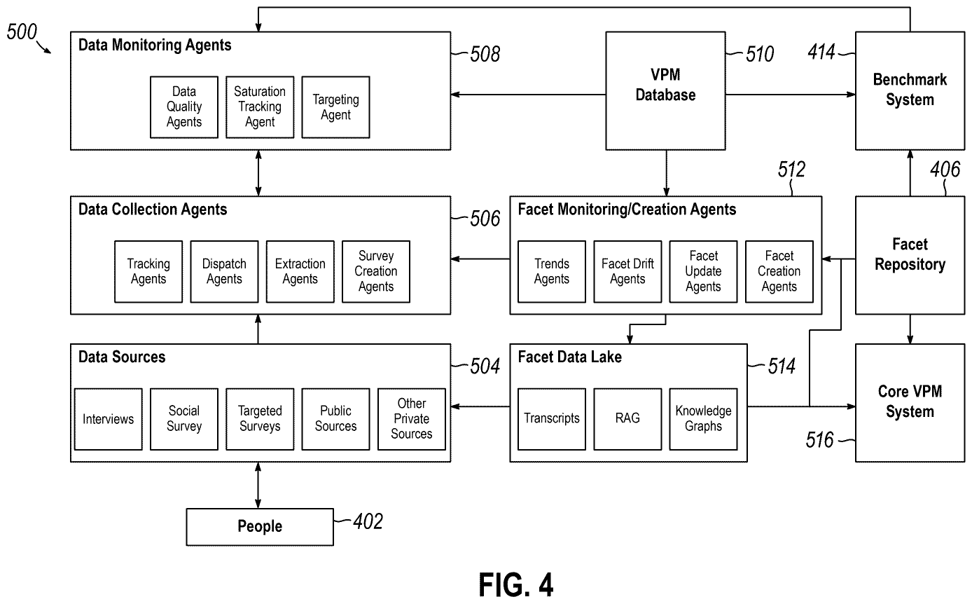

FIG. 4 illustrates an embodiment of a data engine 500 (such as data engine 404, as shown in FIG. 3). Data engine 500 may include data sources 504 sourced from people data 402, one or more data collection agents 506, one or more data monitoring agents 508, a database 510, one or more facet monitoring and/or creation agents 512, and a facet data lake 514. The data engine 500/404 may be configured to communicate with benchmark system 414, facet repository 406, and core system 516. In some embodiments, the core system 516 may be the persona generation server 400 of FIG. 3. Data sources 504 may include one or more recorded interviews which may be recorded by video recording, written, or audio recording; one or more social surveys; one or more targeted surveys; one or more public sources; one or more private sources; or other available sources. Some data may be acquired from people responding to surveys or interviews. Other data may be acquired by scraping online sources for relevant information. These data sources 504 may be stored on the one or more data management servers 112. In some embodiments, the data engine 404 may instead be stored on the one or more persona generation servers 106. In such embodiments, the data sources 504 may be stored on the one or more data management servers 112.

One or more data collection agents 506 may include one or more tracking agents, one or more dispatch agents, one or more extraction agents, one or more survey creation agents, or other agents. The one or more data collection agents 506 may include generative AI, natural language processing, or other AI/ML tools. Tracking agents may collect and monitor the data sources 504 and the input coming from such data sources 504. Dispatch agents may optimize scheduling and deployment of resources including the data sources 504 within the data engine 404. Extraction agents may extract key data from the data sources 504 such that the extracted data can be used to aid in the validation of AI personas and the creation of AI personas.

Survey creation agents may generate custom surveys for people and/or AI personas to take. Survey creation agents may include generative AI, natural language processing, or other AI/ML tools. Survey creation agents may generate surveys based on the data sources 504 which may include questions directed at certain facets. For example, a facet may be gender and may be set to male and the survey may be configured to determine the opinions males have on the best grocery store. A question may be generated as part of a survey directed to males that asks what their favorite grocery store is and why. A survey may contain multiple questions directed at certain opinions or goals and certain facets.

In some versions, the survey creation agents may implement indirect elicitation protocols that may surface latent beliefs without directly asking for them. For example, instead of querying a persona's explicit attitude toward a brand, the system can pose proxy tasks (e.g., choosing between scenarios, summarizing what a friend “said,” predicting the next action, etc.) thereby revealing underlying heuristics in a manner less prone to self-report bias.

The data collection agents 506 may share select data from the data sources 504, survey questions, resource data, or other relevant data with the one or more data monitoring agents 508. The data collection agents 506 may include or utilize generative AI, natural language processing, LLMs (large language models), or other AI/ML tools. Data monitoring agents 508 may include data quality agents, saturation tracking agents, targeting agents, or other agents. Data monitoring agents 508 may include generative AI, natural language processing, LLMs, or other AI/ML tools. Data quality agents may track and monitor the quality of AI personas, the data sources 504, or other key data by ensuring the data is consistent and accurate between AI personas with certain facets and the data sources 504. Saturation tracking agents may track and maintain saturation points for questions on the surveys generated by the survey creation agents. The saturation tracking agents may adapt the surveys and/or survey questions provided by the survey creation agents based on one or more saturation points. The saturation tracking agents can adapt the frequency of certain questions on surveys based on a saturation point. For example, if a subset of people with similar facets answer the same questions and the answers are generally the same, with some minimal level of variance, then that question and facet have met a saturation point. Once a saturation point has been met, the frequency of the question may be lowered by the saturation tracking agents. If a question has not met a saturation point, the question may be added to surveys more frequently. To maintain accuracy, a question that has reached a saturation point may continue to be asked to ensure the saturation point stays met. If a question that previously met its saturation point then starts receiving answers that do not match the general answer associated with the saturation point, the frequency of that question on surveys may be increased until a new saturation point is met. A saturation point may be a number of responses, and the number of responses may be correlated to the breadth of the group within the facet being surveyed, the level of detail of the answers to the question, or other relevant factors. Targeting agents may create new population segmentations or select existing segmentations-based data shared by data collection agents 506. For example, a targeting agent could detect the lack of responses from a male segment during collection of data for updating a Gen Z facet. The targeting agent may then direct data collection agents 506 to increase focus on Gen Z males until the data is sufficiently balanced. Sufficiently balanced may include having a number of responses in a particular segment reflective of a particular population or other metric. The database 510 may be a central database for storage of the data sources 504, data from the data collection agents 506, AI personas and relevant data, or other relevant data. The database 510 may be in communication with the other elements of the data engine 404.

Facet monitoring and/or creation agents 512 may include trends agents, facet drift agents, facet update agents, facet creation agents, and/or other agents. Facet monitoring and/or creation agents 512 may include generative AI, natural language processing, LLMs, or other AI/ML tools. Trend agents may monitor trends and changes to trends among varying facets based on the data sources 504, data provided by the data collection agents 506, and data provided by the data monitoring agents 508. Facet drift agents may monitor and track when opinions and/or characteristics of facets change, merge, or otherwise differ from the previous consensus. Facet update agents may update facets based on data provided by the facet drift agents and/or trend agents. For example, if Gen Z women previously generally preferred pop music as their favorite genre of music, but the data monitoring agents start receiving a significant number of responses from Gen Z women saying R&B is their favorite genre of music, the facet update agents may inform the data collection agents such that the data collection agents may update the surveys and data accordingly and may update the facet repository 406 accordingly.

The facet monitoring and/or creation agents 512 may communicate key data, like trend changes, facet drifts, and/or other information, with the facet data lake 514. Facet data lake 514 may be a centralized repository for varying data regarding the varying facets. The facet data lake 514 may include transcripts from the data sources 504; a retrieval-augmented generation (“RAG”) framework; knowledge graphs based on data from the facet monitoring and/or creation agents 512, data monitoring agents 508, data collection agents 506, and/or other relevant data; and/or other facet data. The data from the facet data lake 514 may be accessible by the core system 516. The benchmark system 414 may receive data from the database 510 and/or the facet repository 406. This data may include facet data, trend data, saturation data, or other relevant data. The benchmark system 414 may feed data regarding the validation of AI personas to the cores system 516. The facet repository 406 may communicate relevant facet data and/or organized facet data with the core system 516, benchmark system 414, and/or facet monitoring and/or creation agents 512.

In some versions, the data engine 500 may include a data supplier registry and a facet attribution ledger which may together record provenance for each facet value or option incorporated into the facet repository 406. A provenance tracker may be included as well to maintain per-supplier lineage, time of ingestion, license or consent terms, and/or usage scope, while a weighting engine may assign reliability weights to suppliers (e.g., enterprise first-party panels, commercial audience-measurement sources, third-party market studies, public signals, etc.) and propagate those weights into benchmarking and inference. A compliance module may be included to enforce data-source usage restrictions at query time and during model training, and can surface attribution summaries to administrators for auditability. The ledger-based approach may allow downstream persona explanations to include data-source attribution where appropriate.

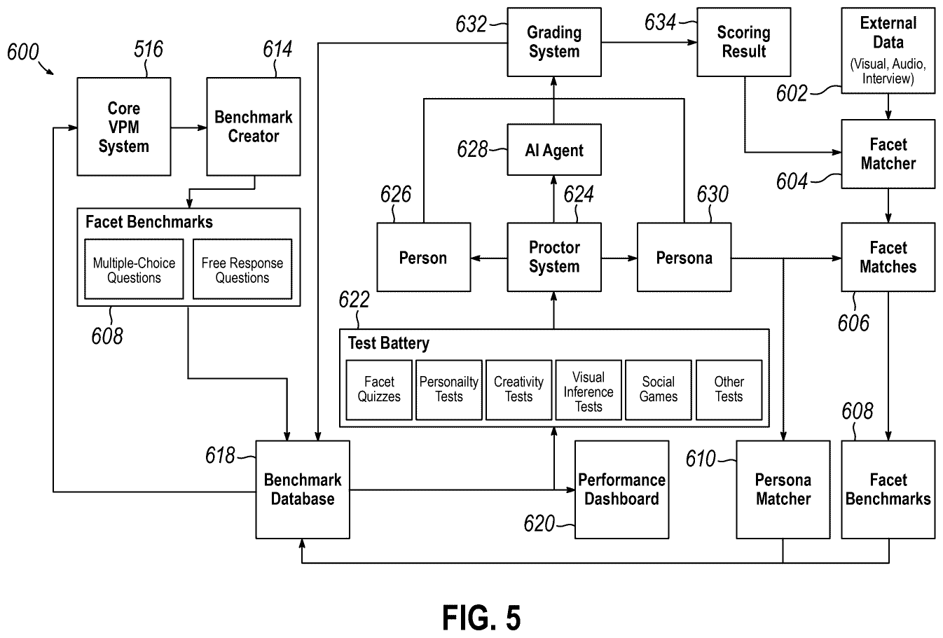

FIG. 5 illustrates an embodiment of benchmark system 600 (such as e.g., benchmark system 414 as described in FIG. 3). The benchmark system 600 may include a facet matcher 604, a facet benchmark generator 608, a persona matcher 610, a benchmark database 618, a core system 516, a benchmark creator 614, a test battery 622, a proctor system 624, and a grading system 632. The facet matcher 604 may receive external data 602, which may be visual, audio, written, or other data. The facet matcher 604 may then match the external data 602 to one or more facets relevant to the external data 602 to form facet matches 606. The facet matcher 604 may then output the facet matches 606. The facet matches 606 may then be shared with the facet benchmark generator 608 and the persona matcher 610. The facet benchmark generator 608 may generate multiple-choice questions and/or free response questions based on the facet matches 606. The persona matcher 610 may match the facet matches 606 to one or more AI personas. The matched AI personas from the persona matcher 610 and the facet benchmarks from the facet benchmark generator 608 may be sent to the benchmark database 618. The benchmark database 618 may house facet benchmarks and benchmark goals. A facet benchmark may be a score depicting how closely an AI persona(s)'s responses are to expected and/or people interview responses. The benchmark database 618 may share the benchmark data with the core system 516 and/or the test battery 622. The core system 516 may store the benchmark data from the benchmark database 618 and/or share the benchmark data with the benchmark creator 614. The benchmark creator 614 may generate one or more metrics that, if met, show that an AI persona is accurately reflecting the opinion of its related facets. The benchmark creator 614 may send these metrics and the related facets to the facet benchmark generator 608. The facet benchmark generator 608 may then generate multiple choice questions, free response questions, or other relevant questions based on the metrics and related facets. The results of the facet benchmark generator 608 may be sent to the benchmark database 618 for storage.

The benchmark database 618 may house varying benchmark data as described above. The benchmark database 618 may share the results with the performance dashboard 620. The performance dashboard 620 may display metrics representing the accuracy of one or more AI personas, people data sufficiency, facet-specific accuracy, question-specific accuracy, or other success metrics. These metrics may be displayed as graphs, charts, or other representations. The benchmark database 618 may also send the benchmark data to the test battery 622. The test battery 622 may generate a variety of tests based on the benchmark data and questions from the benchmark database 618. The tests may include facet quizzes, personality tests, creativity tests, visual inference tests, social games, and/or other tests. The test battery 622 may send the generated tests to the proctor system 624.

The proctor system 624 may conduct testing based on the generated tests. This testing may be given to one or more people 626, one or more AI personas 630, and/or one or more AI agents 628. Once the person 626, AI agent 628, and/or the AI persona 630 completes the testing, the responses may be passed to the grading system 632. The grading system 632 may assess the responses. This assessment may include comparing responses from the person 626, AI agent 628, and/or AI persona 630 to determine a scoring result 634 representing how closely the AI agent 628 and/or AI persona's responses match the person's 626 responses. This may allow the system to determine whether the AI persona 630 and/or AI agent 628 is accurate, up to date, and a realistic representation of a person with similar facets. The grading system 632 may share the scoring result 634 with the facet matcher 604. The facet matcher 604 may then determine which facet(s) is relevant to the scoring result 634. From there, the system may continue to test, compare, and improve surveys, AI personas, and/or AI agents based on the grading system and performance. The proctor system 624 and grading system 632 may score proxy tasks, like those discussed above, against people data 402 to calibrate latent-insight prompts and to update benchmark goals in the benchmark database 618.

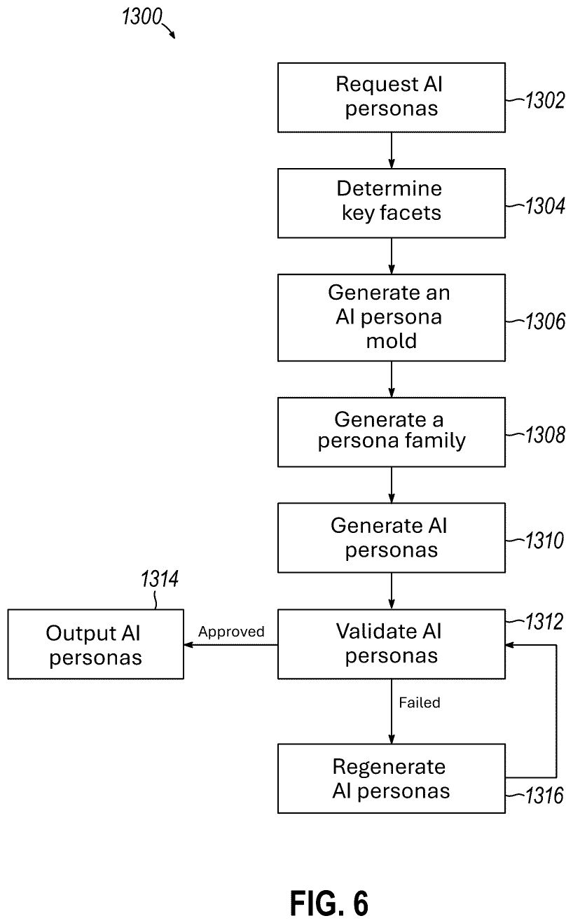

FIG. 6 illustrates a method 1300 for generating AI personas. First, one or more AI personas may be requested 1302 by a user via the one or more computing devices 102, 104 of FIG. 1. A request may include a written description of a type of consumer, a verbal description of a type of consumer, a selection of persona preferences, an example consumer, or other description. Then the one or more persona generation servers 106 may determine key facets 1304 to aid in the generation of AI personas based on the request. This determination may be completed by the one or more persona generation servers 106 and/or an AI/ML engine. This determination may include a user analyzing the request for key facets that may be relevant to the type of personas in the request. In some embodiments, this determination may include an AI/ML engine taking the request as input and outputting a list of one or more key facets relevant to the type of personas in the request as described below. After key facets are determined 1304, an AI persona mold 408 may be generated 1306. Next, a persona family 410 may be generated 1308.

After a persona family 410 is generated 1308, varying AI personas may be generated 1310 that fit the characteristics within the AI persona mold 408 and/or persona family 410. The one or more persona generation servers 106 may generate the varying AI personas based on the desired facets, varied facets, and optional facets. This may be completed by the one or more persona generation servers 106 storing the persona family 410, pulling data on each facet and facet option from the one or more data management servers 112, and using an LLM, generative AI, SLM, speech recognition models, computer vision models, and/or other AI/ML models to generate each AI persona based on the designated facet, facet options, and frequencies. Options for the varied facets may be chosen randomly from a group of options or weighted in a desired fashion such that certain options are chosen more frequently than others. For example, options may be weighted in accordance with a sample of a geographic population and the frequency each option occurs within that geographic population.

In some versions, prior to validation 1312, AI personas can be selected from pre-built, reusable populations maintained by a population repository, followed by enterprise-specific screening to meet sponsor criteria (e.g., geography, media behaviors, ownership, past-purchase signals, etc.). An output 1314 can optionally provide a biographical summary for each AI persona, which may include stable facets, knowledge states, recent exposures, and/or rationales (e.g., inner monologues) used in concept testing, which may assist auditors and sponsors in interpreting downstream rankings.

In some embodiments, the method may continue by validating the generated AI personas 1312. Validation may include benchmark system 414. If an AI persona is approved, the AI persona may be displayed as output 1314 to a user such that a user can begin interacting with the AI persona. If the AI persona fails the validation, validation test data and the AI persona may be passed back to one or more persona generation servers 106 such that the AI persona may be regenerated 1316 and/or updated according to the validation test data. This validation process may run iteratively until the AI persona is validated. In some embodiments, this validation process may continue to occur at regular or random intervals after the AI persona is validated such that the AI persona maintains an accurate reflection of a person with its designated facets.

In some versions, the system 100 can construct a world-state snapshot representing a given time and given market, and execute an agent-based simulation engine that can propagate messages through a social-influence graph, which may be parameterized by influencer nodes and group-dynamics coefficients. The simulation engine can expose a multimodal media decomposition module that may parse stimuli (e.g., film trailers, ads, promotional media, etc.) into semantic, auditory, and/or visual descriptors aligned to facets and/or knowledge states, which may enable persona-level and/or cohort-level response modeling under different dissemination schedules and creative variants.

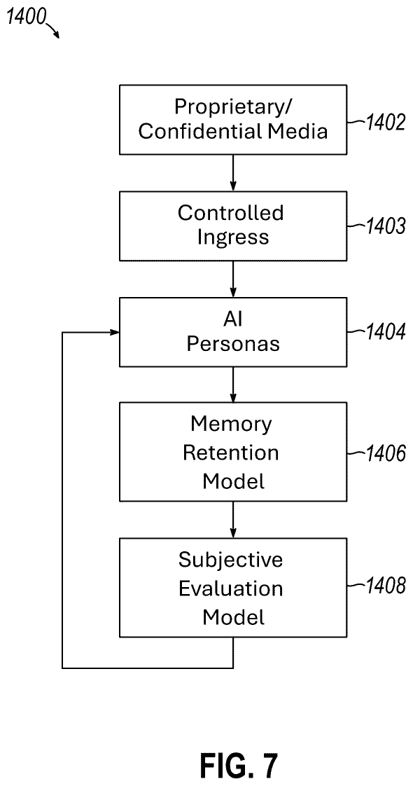

FIG. 7 illustrates an exemplary data-flow architecture 1400 in which proprietary or otherwise confidential media 1402 may be securely provided to a cohort of AI personas 1404 for internal processing, memory state updating, and evaluative output generation. The proprietary media 1402 may include unreleased advertisements, promotional materials, product concepts, audiovisual content, or any sensitive asset which may be introduced into an access-restricted computational environment designed to prevent exposure to human subjects or unauthorized systems. In some versions, the media 1402 may be admitted through a controlled ingress mechanism 1403 that can enforce cryptographic access controls, ephemeral storage, and/or execution within an isolated runtime so that only machine-resident components may interact with the media 1402.

The controlled ingress mechanism 1403 may govern admission of proprietary or otherwise confidential media 1402 into an evaluation environment of FIG. 7. The controlled ingress 1403 may implement cryptographic access controls, ephemeral storage, and/or isolated runtime execution so that machine-resident components may process the media while preventing exposure to human subjects and/or unauthorized systems. The controlled ingress 1403 may expose a dedicated intake endpoint that may require authenticated submission from pre-registered entities. Upon receipt of a media package, the ingress may verify submitter credentials and evaluate submission metadata (e.g., declared media type, size, retention preference, etc.) against a policy set prior to admission into the sandbox. Submissions that fail authentication or violate policy may be quarantined or rejected without entering the evaluation pipeline. Before any internal processing, the controlled ingress 1403 may enforce cryptographic gating by accepting only media that is encrypted under system-recognized keys, or by encrypting admitted media at the boundary and storing keys in a vault that is accessible solely to the isolated runtime. Keys may not be released to user interfaces or non-sandbox services, thereby maintaining leak-prevention.

The ingress may stage admitted media within ephemeral storage allocated for a single evaluation session. Storage may be configured with automatic zeroization or secure deletion at session completion or upon fault detection. After cryptographic and policy validation, the ingress may transfer the media into an isolated runtime (e.g., a containerized or sandboxed execution context dedicated to the persona cohort scheduled for evaluation). As described, this isolated runtime may ensure that only machine-resident components (e.g., persona interpreters, memory-retention models, and subjective evaluation models) can access the media, thereby preventing human-subject exposure during focus-group-style evaluations.

Upon receiving the media 1402, each AI persona 1404 may interpret the media 1402 according to the AI persona's configured traits, internal facet structure, reasoning style, and/or cognitive parameters. This initial interpretation may include multimodal parsing of audio and/or video streams, semantic extraction of narrative or symbolic elements, affective inference from tonal or visual cues, and/or transformation of the media 1402 into a latent representation that can be combined with, or conditioned on, an existing persona state. In some versions, the AI personas 1404 may execute this interpretation synchronously to maintain consistent timing across a cohort. In other versions, the AI personas 1404 may operate asynchronously according to persona-specific attention profiles, weighting schemes, and/or interpretation modules that may amplify or attenuate particular features of the media 1402 to reflect cohort heterogeneity.

The latent representation produced by each AI persona 1404 may then be provided to a memory retention model 1406, which may update the AI persona's internal memory state with respect to the newly encountered media 1402. The memory retention model 1406 may implement deterministic or stochastic retention curves, multi-stage memory encoding that may separate immediate impressions from longer-term storage, decay-based recall functions that may reduce availability over time, episodic-style storage architectures with time-indexed records, associative memory graphs that may link new content to previously stored representations, and/or reinforcement-updated recall structures that may increase stability for frequently referenced items. These mechanisms may enable the system to simulate a variety of memory behaviors, which may include rapid short-term impression formation, time-dependent forgetting, and/or persistent anchoring for stimuli that are intended to remain salient across subsequent evaluations.

After memory updating, the resulting persona memory state may be transmitted to a subjective evaluation model 1408, which may generate evaluative outputs based on each AI persona's internalized representation of the media 1402. The subjective evaluation model 1408 may produce scalar sentiment values, multidimensional attitudinal vectors, preference rankings, perceptual classifications, narrative rationales, and/or other qualitative or quantitative indicators. In some versions, the model 1408 may include neural-network reasoning layers tuned for comparative judgments, rule-augmented scoring engines that enforce domain-specific evaluation criteria, ensemble evaluators that include multiple independent assessments, and/or probabilistic classifiers that may output categorical judgments and/or confidence values. The model 1408 can additionally emit secondary outputs, such as predicted next actions, inferred intent, emotional resonance estimates, credibility assessments, and/or certainty measures that qualify the primary evaluations.

As shown in FIG. 7, evaluative outputs from the subjective evaluation model 1408 may be fed back to the AI personas 1404 which may enable iterative refinement, multi-cycle reasoning loops, and/or reflective recalibration of persona state. This feedback loop may allow an AI persona to reinterpret ambiguous portions of the media 1402, resolve inconsistencies that arise during successive reasoning passes, and/or perform additional internal analysis before producing a final reportable output. In some versions, the loop may execute for a fixed number of cycles which may guarantee bounded latency. In other versions, the loop may proceed until a convergence criterion is met, such as stabilization of sentiment within a predefined tolerance, attainment of a target confidence level, or expiration of a time or compute budget.

In some versions, additional intermediate modules may be included between any two stages. For example, a contextual relevance filter may suppress evaluative outputs that fall outside an AI persona's modeled domain of knowledge, which may prevent spurious confidence in areas where the AI persona would be unlikely to have meaningful exposure. An exposure-normalization layer may adjust for differences in simulated prior exposure across AI personas which may ensure that cohort-level rankings reflect controlled exposure parity rather than prior familiarity. A bias-mitigation component may counteract systematic distortions introduced by particular facet combinations and/or reasoning styles. A stochastic persona-ensemble sampler may spawn multiple divergent interpretations for a single persona configuration to simulate intra-group variability. A temporal-progression engine may simulate delayed reactions or evolving interpretations, which may enable evaluation at multiple virtual timepoints following the initial viewing of media 1402.

In some versions, AI personas 1404 may be configured to apply cognitive-style-specific processing pathways so that the flow from media 1402 through memory retention 1406 and subjective evaluation 1408 may reflect diverse perceptual and interpretive behaviors. For example, certain AI personas may prioritize sensory detail and surface-level pattern recognition, while others may emphasize symbolic interpretation, contextual relevance, and/or socially informed inference. The architecture of FIG. 7 may allow persona-specific preprocessors prior to memory updating and may permit evaluator-specific heads within the subjective evaluation model 1408 that may select or fuse intermediate representations appropriate to the AI persona's profile.

Although FIG. 7 presents a linear sequence from proprietary media 1402 to personas 1404, then to memory retention 1406 and subjective evaluation 1408, the architecture may be compatible with parallel, branching, and/or multi-channel pathways. Multiple evaluation models 1408 can operate concurrently on different aspects of the same media 1402, such as an emotional channel and a comparative utility channel, with results fused downstream. Likewise, multiple memory retention models 1406 can be run in parallel to simulate distinct retention behaviors for comparison studies. The components may be reordered or partially collapsed when latency or resource constraints warrant, for example by integrating memory updating and evaluation in a joint model that emits both updated state vectors and evaluative outputs in a single pass.

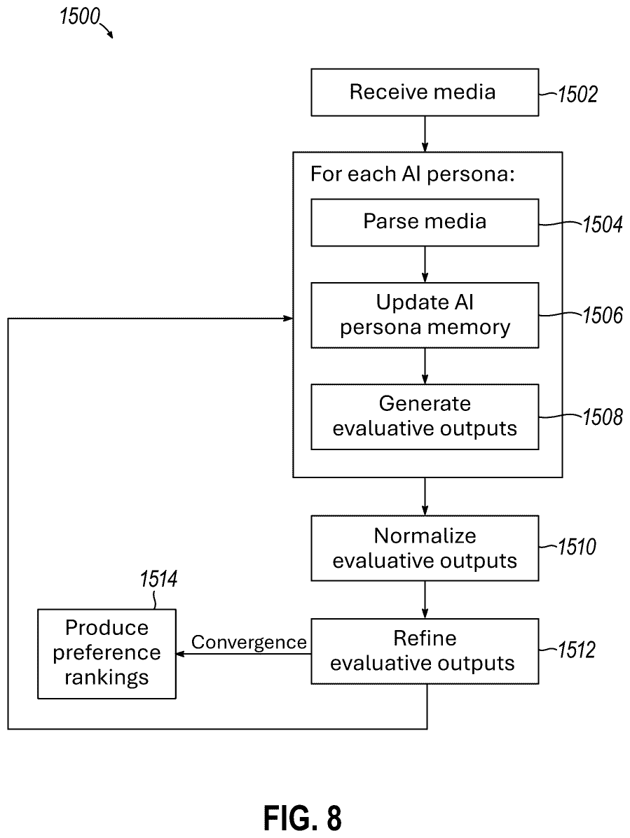

FIG. 8 illustrates an exemplary method 1500 for conducting focus-group-style evaluations using a plurality of AI personas executed by one or more computing devices. First, the system may receive 1502 a media as a stimulus through a controlled ingress that may govern introduction of proprietary or otherwise confidential assets into an access-restricted computational environment. In some versions, the controlled ingress may enforce cryptographic access controls, stage admitted media in ephemeral storage that is scoped to a single evaluation session, and/or execute within an isolated runtime so that only machine-resident components may access the media during processing. This receipt 1502 and admission may include gatekeeping behaviors that may authenticate a submitting entity and validate submission metadata prior to admission, and may provide session-scoped handles for subsequent stages without exposing persistent file handles.

Once received 1502, the media may be evaluated by each AI persona. Each AI persona may parse 1504 the media to obtain a latent representation suitable for downstream models. Parsing 1504 can include multimodal decomposition into semantic, auditory, and/or visual descriptors aligned to AI persona traits. In some versions, AI persona-specific preprocessors may be applied to emphasize or attenuate particular features of the media according to configured reasoning styles, attention profiles, and/or localized defaults. The per AI persona processing may be performed synchronously to maintain consistent timing across the cohort, or asynchronously according to AI persona-specific scheduling to simulate heterogeneous attention and interpretation patterns.

Then AI persona memory may be updated 1506, which may include adjusting the AI persona's internal state using a memory-retention model. In some versions, the memory-retention model may perform multi-stage encoding that distinguishes immediate impressions from long-term storage and applies decay-based recall functions so that later evaluations can differentiate non-exposure, exposure without recall, and/or exposure with recall. The resulting memory state can be stored as time-indexed vectors or associative records that condition the next stage of analysis.

Then the AI personas may generate 1508 one or more evaluative outputs. This may include using a subjective evaluation model to produce AI persona-level outputs conditioned on the latent representation and the updated memory state. Evaluative outputs may include, by way of example, scalar sentiments, multidimensional attitudinal vectors, preference judgments, narrative rationales, predicted next actions, inferred intents, emotional-resonance estimates, credibility assessments, and/or confidence indicators. In some versions, the subjective evaluation model may include evaluator-specific heads, such as an emotional channel and/or a comparative-utility channel, that may be selected or fused based on the AI persona's profile. In some versions, multiple evaluation models may operate in parallel on different aspects of the same media and their outputs may be combined downstream. To satisfy latency constraints, some versions may reorder or partially collapse components so that memory updating and evaluation can execute as a joint model that emits both an updated state and evaluative outputs in a single pass.

After each AI persona has evaluated the media, the evaluative outputs may be normalized 1510. In some versions, an exposure-normalization layer may compensate for differences in simulated prior exposure among the AI personas which may enforce exposure parity prior to aggregation. A bias-mitigation component may reduce systematic distortions associated with particular facet combinations and/or reasoning styles. In some versions, a contextual relevance filter can suppress or down-weight outputs that fall outside an AI persona's modeled domain of knowledge, which may improve reliability of cross-persona comparisons.

The normalized 1510 evaluative outputs may then be refined 1512 where the system may iteratively improve AI persona and/or cohort assessments until a convergence condition is satisfied. This iterative refinement 1512 may include a feedback loop in which intermediate results are provided back to per AI persona processing to resolve inconsistencies and/or stabilize reasoning. Convergence can be defined by sentiment stabilization within a predefined tolerance, attainment of a target confidence level, or expiration of a compute-budget threshold. In some versions, a stochastic AI persona-ensemble sampler may spawn controlled variants of one or more AI personas during refinement 1512 to simulate intra-group variability, and the resulting outputs may be re-introduced into normalization prior to final aggregation.

Upon satisfaction of the convergence condition, cohort-level preference rankings may be produced 1514. These rankings can be accompanied by summary statistics and/or rationales that may assist in interpreting the outcomes across AI personas and/or over time. In some versions, a temporal-progression engine may evaluate the same media at multiple simulated timepoints following an initial viewing to capture delayed reactions or evolving interpretations. In some versions, the system may produce separate cohort-level rankings for each simulated timepoint.

As described above, certain embodiments may incorporate AI/ML aspects. Various embodiments under the present disclosure can incorporate AI/ML functionality. For example, for purposes of the present disclosure, user computing devices 102, 104, persona generation servers 108, 110, and/or data management servers 114, 116, of FIG. 1 can be said to comprise an AI/ML engine, either separately or together. Each component may comprise a separate instance of an identical AI/ML engine. Or a “central” AI/ML engine could be running at any location, such as persona generation servers 108, 110, and others of the foregoing devices could function like an output/input interface to the central AI/ML engine, allowing user input, data collection, user interface for a user, etc. As described above, data management servers 114, 116 may collect data from online sources, receive data from social surveys, track accuracy of AI personas, identify and track trends, receive data from interviews, receive data from target surveys, receive data from third parties such as Google Ads, Facebook, X, etc., or otherwise receive or utilize a variety of other data. This data can be used to analyze what trends are relevant, what facets should be incorporated into AI personas, etc., or other types of metrics. This data can also be used to train AI/ML engine, or can be analyzed by a previously trained AI/ML engine.

It should be understood that AI/ML engine can comprise one or more AI/ML engines. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML engine is intended to denote a variety of AI/ML functionalities that fall under the category of AI or ML algorithms and systems that utilize such functionalities. Examples of AI/ML engines can comprise any one or more of e.g.: supervised learning, reinforcement learning, natural language processing such as LLMs, neural networks, computer vision, facial recognition, chatbots, virtual assistants, unsupervised learning, generative AI, other AI or ML models, and/or combinations of any of the foregoing.

In AI persona generation system 100 of FIG. 1, multiple AI/ML engines can be used. For example, one AI/ML engine can comprise a LLM-based chatbot that interacts with any user of AI persona generation system 100 to determine an AI persona template, receive requests, or perform other tasks. It may be that multiple different LLMs are used. For example, one LLM might be trained on consumer data. Another might be trained on trend. A different AI/ML engine may be stored or implemented at various of the components shown in FIG. 1. Alternatively, there may be a smaller number of AI/ML engines, and various of the components of FIG. 1 may function as user interfaces for a remote AI/ML engine stored at e.g., persona generation server 108. Data used to train, retrain, or implement any of AI/ML engines may be stored at any one or more of the components shown in FIG. 1. A person of ordinary skill in the art will recognize that a variety of such variations are possible under the present disclosure.

The architecture of an AI/ML engine (e.g., structure, number of layers, nodes per layer, activation function etc.) may need to be tailored for each particular use case. For example, properties to vary can include e.g.: description of desired AI personas, accuracy benchmarks, amount of AI personas, preferred level of detail, and a variety of other factors. These may all need to be considered when designing an AI/ML engine architecture.

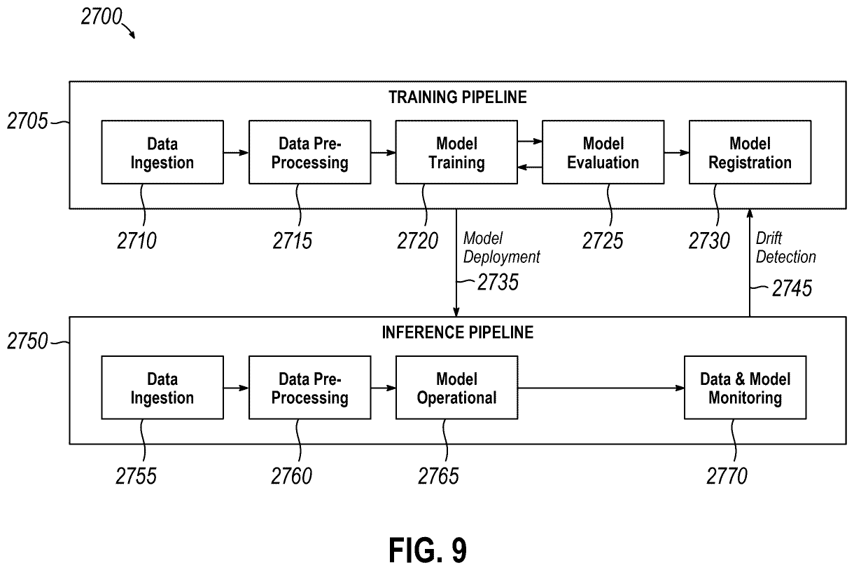

Building an AI/ML engine can include several development steps where the actual training of a ML model or algorithm is just one step in a training pipeline. An important part in AI/ML development is AI/ML model lifecycle management. One embodiment of a model lifecycle management procedure 2700 is illustrated in FIG. 9. The model lifecycle management can in some embodiments comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on maximizing facet accuracy or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model (e.g., AI/ML engine) is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., AI persona generation system 100 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

Parameter optimization: The gradients computed in the back propagation step are used to update the ML model's trainable parameters. An approach is to use the gradient descent method with a learning rate hyperparameter (α) that scales the gradients of the weights and biases. It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in AI persona generation system 100 of FIG. 1 (e.g., in the form of simple vector-matrix multiplications).

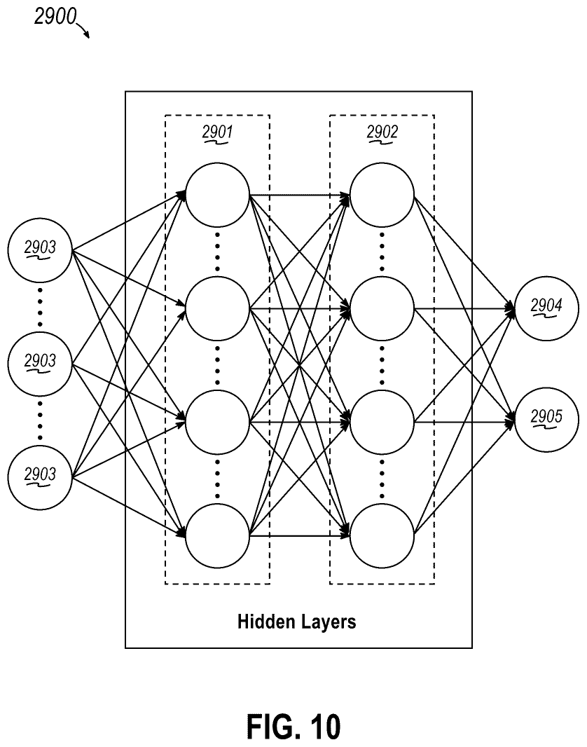

Referring now to FIG. 10, an example NN 2900 (e.g., DNN) is shown. In some implementations, and as shown, the neural network 2900 may include two hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may be output (e.g., as an output layer) as outputs 2904, 2905. Outputs 2904, 2905 could be, e.g., an AI persona family, recommended AI persona facets, an AI persona template; or another output valuable. Possible inputs can include e.g.: description of AI persona type, or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

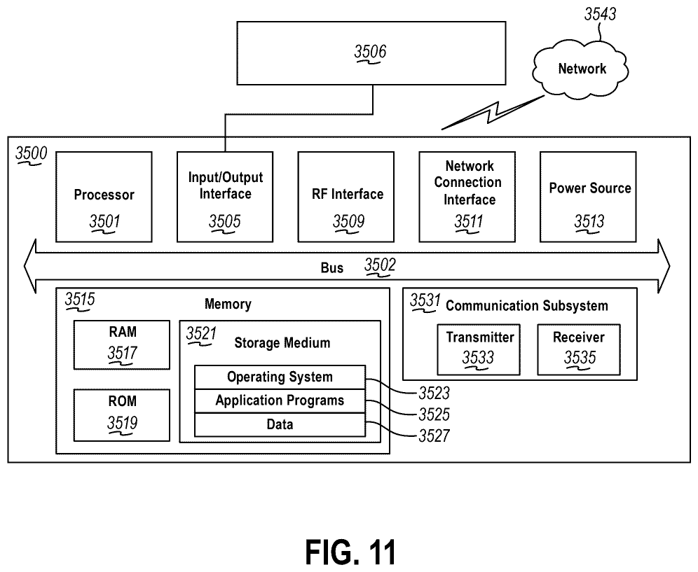

FIG. 11 illustrates an embodiment of various computing devices within AI persona generation system 100 of FIG. 1, or components thereof e.g., user computing devices 102, 104, persona generation servers 108, 110, and/or data management servers 114, 116, which can comprise e.g., computers, tablets, servers, databases, mobile devices, or other computing or smart devices described herein. FIG. 11 shows a schematic block diagram of a computing device 3500 (or components thereof) according to certain embodiments of the present disclosure. System 3500 can be used to analyze and/or optimize: the functionalities described with respect to AI persona generation system 100 of FIG. 1 and its components, or to perform other methods, such as DLT, AI or ML-related tasks and analyses as described herein.

Computing device 3500 includes processor 3501 that is operatively coupled via a bus 3502 to an input/output interface 3505, a power source 3513, a memory 3515, a RF interface 3509, network communication interface 3511, and/or any other component, or any combination thereof. The level of integration between the components may vary from one embodiment to another. Further, certain computing devices 3500 (or components thereof) may contain multiple instances of a component, such as multiple processors, memories, transceivers, transmitters, receivers, etc.

The processor 3501 is configured to process instructions and data and may be configured to implement any sequential state machine operative to execute instructions stored as machine-readable computer programs in memory 3515. Processor 3501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 3501 may include multiple central processing units (CPUs).

In the example, input/output interface 3505 may be configured to provide an interface or interfaces to an input/output device(s) 3506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 3500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 3513 is structured as a battery or battery pack. Other types of power sources, such as an external power source (e.g., an electricity outlet), photovoltaic device, or power cell, may be used. The power source 3513 may further include power circuitry for delivering power from the power source 3513 itself, and/or an external power source, to the various parts of computing device 3500 via input circuitry or an interface such as an electrical power cable.

Memory 3515 may be configured to include memory such as random access memory (RAM) 3517, read-only memory (ROM) 3519, programmable read-only memory (PROM), erasable programmable read-only memory (EPROM), electrically erasable programmable read-only memory (EEPROM), magnetic disks, optical disks, hard disks, removable cartridges, flash drives, other storage medium 3521, and so forth. In one example, the memory 3515 includes one or more application programs 3525, an operating system 3523, web browser application, a widget, gadget engine, or other application, and corresponding data 3527. Memory 3515 may store, for use by the computing device 3500, any of a variety of various operating systems or combinations of operating systems. An article of manufacture, such as one including a simulation system or communication system may be tangibly embodied as or in memory 2515, which may be or comprise a device-readable storage medium.

Processor 3501 may be configured to communicate with an access network or other network using the RF interface 3509 or network connection interface 3511. The RF interface 3509 or network connection interface 3511 may comprise one or more communication subsystems and may include or be communicatively coupled to an antenna. In the illustrated embodiment, communication functions of the RF interface 3509 or network connection interface 3511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

AI persona generation system 100 of FIG. 1, or computing devices 3500 as described above or in regard to FIG. 1, can perform a variety of method embodiments under the present disclosure. Several example method embodiments are given described above but these examples are non-limiting and are only meant to illustrate certain embodiments.

Although the computing devices described herein (e.g., servers, computing devices, etc. of AI persona generation system 100 of FIG. 1) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in other components, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

What is claimed is:

1. A computer-implemented method performed by a persona generation server comprising one or more processors and memory, the method comprising:
a) receiving, via a user interface, a request for one or more artificial-intelligence (AI) personas;
b) determining, by the persona generation server, a plurality of key persona facets for the request;
c) generating an AI persona mold based on the plurality of key persona facets;
d) generating, by an artificial intelligence/machine learning (AI/ML) model, a plurality of AI personas consistent with the persona mold; and
e) validating the plurality of AI personas based on one or more validation criteria.

2. The method of claim 1, wherein validating the plurality of AI personas comprises using a benchmark system that applies facet-specific tests and compares AI persona responses to people-data.

3. The method of claim 1, further comprising when validation criteria are not met, regenerating the plurality of AI personas based on validation feedback and re-validating until the one or more validation criteria are met.

4. The method of claim 1, wherein generating the AI persona mold comprises selecting one or more fixed facets and one or more variable facets from a facet repository that stores, for each facet, at least one of: a short name, a display name, a description, a dimensionality, a selection type, facet options, a category, and metadata.

5. The method of claim 1, further comprising constructing a persona family that enumerates one or more options and one or more associated frequencies for the one or more variable facets, and wherein generating the plurality of AI personas comprises sampling one or more facet options according to one or more frequencies specified by the persona family.

6. The method of claim 5, wherein the one or more frequencies specified by the persona family are weighted to match a target population distribution produced by a population constructor module.

7. The method of claim 1, wherein generating the plurality of AI personas comprises, for each of the AI personas:
a) assigning one or more knowledge facets;
b) computing one or more exposure estimates based on a media-consumption facet; and
c) parameterizing a memory-retention model to control recall dynamics for downstream evaluations.

8. The method of claim 1, wherein determining the plurality of key persona facets comprises executing one or more survey-creation agents to generate a plurality of facet-targeted questions and ingesting a plurality of responses from people data sources to weight the importance of one or more candidate facets.

9. The method of claim 1, wherein generating the plurality of AI personas comprises configuring one or more persona reasoning-style parameters, comprising at least one of: inner-monologue verbosity or cognitive-style-specific processing pathways.

10. A computer-implemented method for conducting focus-group-style evaluations using AI personas, comprising:
a) receiving media through a controlled ingress;
b) for each of a plurality of AI personas:
i) parsing the media to obtain a latent representation;
ii) updating AI persona memory using a memory-retention model; and
iii) generating evaluative outputs using a subjective evaluation model;
c) normalizing the evaluative outputs across the plurality of AI personas using exposure-normalization and bias-mitigation components;
d) iteratively refining the evaluative outputs until a convergence criterion is met; and
e) producing cohort-level preference rankings for the plurality of AI personas.

11. The method of claim 10 wherein the controlled ingress enforces one or more cryptographic access controls, ephemeral storage, and execution within an isolated runtime.

12. The method of claim 10, further comprising synchronous scheduling of the plurality of AI personas to maintain consistent timing across the plurality of AI personas.

13. The method of claim 10, further comprising asynchronous scheduling of the plurality of AI personas according to one or more persona-specific attention profiles that weight one or more features of the media prior to generating the evaluative outputs.

14. The method of claim 10, wherein the memory-retention model comprises multi-stage encoding that separates immediate impressions from long-term storage.

15. The method of claim 10, wherein normalizing the evaluative outputs further comprises applying an exposure-normalization layer that compensates for differences in simulated prior exposure across the plurality of AI personas to enforce exposure parity before bias-mitigation.

16. The method of claim 10, wherein normalizing the evaluative outputs further comprises applying a contextual relevance filter configured to suppress evaluative outputs that fall outside a modeled domain of knowledge for an AI persona.

17. The method of claim 10, wherein iteratively refining the evaluative outputs comprises iterating a feedback loop in which the evaluative outputs are re-introduced to each AI persona to resolve inconsistencies until the convergence criterion is satisfied.

18. The method of claim 10, wherein the convergence criterion comprises stabilization of sentiment within a predefined tolerance.

19. The method of claim 10, further comprising halting an evaluation session upon fault detection and zeroizing any session-scoped ephemeral storage prior to resuming operation for other sessions.

20. A persona generation system, the system comprising:
processing circuitry;
a memory storing instructions whereby the processing circuitry is operable to perform the steps of:
a) receive, via a user interface, a request for one or more artificial-intelligence (AI) personas;
b) determine, by the persona generation server, a plurality of key persona facets for the request;
c) generate an AI persona mold based on the plurality of key persona facets;
d) generate, by an artificial intelligence/machine learning (AI/ML) model, a plurality of AI personas consistent with the persona mold; and
e) validate the plurality of AI personas based on one or more validation criteria.
